(19) United States
(12) Patent Application Publication
(10) Pub. No.: US 2014/0218819 A1
(43) Pub. Date: Aug. 7, 2014

(54) SPINDLE MOTOR AND RECORDING DISK DRIVING DEVICE INCLUDING THE SAME

(71) Applicant: SAMSUNG ELECTRO-MECHANICS CO., LTD., Suwon (KR)

(72) Inventors: Je Hyun BANG, Suwon (KR); Ho Kyung Jang, Suwon (KR)

(21) Appl. No.: 13/916,300

(22) Filed: Jun. 12, 2013

(30) Foreign Application Priority Data
Feb. 5, 2013 (KR) 10-2013-0012685

(51) Int. Cl. H02K 7/08; G11B 17/34; G11B 5/012

(52) U.S. Cl. CPC H02K 7/086; G11B 5/012; G11B 17/34
USPC 360/71; 310/90

(57) ABSTRACT

There is provided a spindle motor including: a rotating member including a protrusion portion protruded so as to form a clearance narrower than a bearing clearance; and a fixed member having a protrusion corresponding portion protruded so as to be disposed to face the protrusion portion and rotatably supporting the rotating member, wherein the protrusion portion includes a thrust dynamic pressure groove formed therein in order to generate thrust fluid dynamic pressure and has a radial length smaller than that of the protrusion corresponding portion disposed to face the thrust dynamic pressure groove and having a flat surface.

### CROSS-REFERENCE TO RELATED APPLICATIONS

This application claims the priority of Korean Patent Application No. 10-2013-0012685 filed on Feb. 5, 2013, in the Korean Intellectual Property Office, the disclosure of which is incorporated herein by reference.

### BACKGROUND OF THE INVENTION

1. Field of the Invention

The present invention relates to a spindle motor and a recording disk driving device including the same.

2. Description of the Related Art

Generally, a small-sized spindle motor used in a hard disk drive (HDD) is provided with a hydrodynamic bearing assembly, and a bearing clearance may be formed between a shaft, a thrust member, and a sleeve of the hydrodynamic bearing assembly, and the bearing clearance may be filled with a lubricating fluid such as oil. In addition, the oil provided in the bearing clearance generates fluid dynamic pressure while being pumped, thereby rotatably supporting a rotating member.

For example, generally, the hydrodynamic bearing assembly is provided with a thrust dynamic pressure groove having a spiral pattern and a radial dynamic pressure groove having a herringbone pattern and generates dynamic pressure through the above-mentioned grooves to promote stability in rotation of the spindle motor.

In addition, the radial dynamic pressure groove for generating fluid dynamic pressure groove in a radial direction includes upper and lower radial dynamic pressure grooves formed in an inner surface of the sleeve.

Further, the thrust dynamic pressure groove may be formed in the sleeve and/or in the thrust member in order to generate fluid dynamic pressure in an axial direction. Further, in order to more smoothly generate the fluid dynamic pressure, a gap between portions of the sleeve and the thrust member in which the thrust dynamic pressure grooves are located may be smaller than a gap of the bearing clearance in which the lubricating fluid is provided.

Meanwhile, in order to maximize the above-mentioned effect, the portion of the sleeve and/or the thrust member in which the thrust dynamic pressure groove is formed and a portion of the sleeve and/or the thrust member disposed to face the portion of the sleeve and/or the thrust member in which the thrust dynamic pressure groove is formed may be protruded toward each other.

However, in the case in which an edge of either of the portions protruded as described above contacts the rotating member at the time of rotation thereof, foreign objects may be generated due to abrasion. Further, the foreign objects generated due to the abrasion of the edge maybe introduced into the lubricating fluid to deteriorate rotational characteristics.

### RELATED ART DOCUMENT

(Patent Document 1) Japanese Patent Laid-Open Publication No. 2008-69805

### SUMMARY OF THE INVENTION

An aspect of the present invention provides a spindle motor capable of preventing damage to a thrust dynamic pressure groove and preventing generation of foreign objects, and a recording disk driving device including the same.

According to an aspect of the present invention, there is provided a spindle motor including: a rotating member including a protrusion portion protruded so as to form a clearance narrower than a bearing clearance; and a fixed member having a protrusion corresponding portion protruded so as to be disposed to face the protrusion portion and rotatably supporting the rotating member, wherein the protrusion portion includes a thrust dynamic pressure groove formed therein in order to generate thrust fluid dynamic pressure and has a radial length smaller than that of the protrusion corresponding portion disposed to face the thrust dynamic pressure groove and having a flat surface.

The fixed member may include a base member including an installation part on which a stator core is installed; a lower thrust member inserted into the installation part; and a shaft having a lower end portion fixedly installed in the lower thrust member and an upper end portion provided with a flange part.

The rotating member may include a sleeve forming, together with the lower thrust member and the shaft, the bearing clearance; and a rotor hub extended from the sleeve.

The protrusion portion may be formed on at least one of upper and lower surfaces of the sleeve, and the protrusion corresponding portion may be formed on at least one of the lower thrust member and the flange part.

The lower thrust member may include a disk part having a disk shape and provided with a through-hole; and a sealing wall part extended from an edge of the disk part upwardly in an axial direction and having a distal end portion disposed to be adjacent to a lower surface of the rotor hub.

The rotor hub may be provided with an extension wall part for forming, together with an outer peripheral surface of the flange part, a labyrinth seal.

The spindle motor may further include a cap member fixedly installed on the extension wall part to prevent leakage of a lubricating fluid.

According to another aspect of the present invention, there is provided a spindle motor including: a base member including an installation part on which a stator core is installed; a lower thrust member inserted into the installation part; a shaft having a lower end portion fixedly installed in the lower thrust member and an upper end portion provided with a flange part; a rotating member including a sleeve forming, together with the lower thrust member and the shaft, a bearing clearance and a rotor hub extended from the sleeve; and a cap member fixedly installed on the rotor hub to prevent leakage of a lubricating fluid from a liquid-vapor interface disposed in a space formed between the flange part and the rotor hub, wherein at least one of upper and lower surfaces of the sleeve is provided with a protrusion portion, and at least one of a lower surface of the flange part and an upper surface of the lower thrust member is provided with a protrusion corresponding portion corresponding to the protrusion portion, the protrusion portion including a thrust dynamic pressure groove formed therein in order to generate thrust fluid dynamic pressure and having a radial length smaller than that of the protrusion corresponding portion.

The lower thrust member may include a disk part having a disk shape and provided with a through-hole; and a sealing wall part extended from an edge of the disk part upwardly in an axial direction and having a distal end portion disposed to be adjacent to a lower surface of the rotor hub.

The rotor hub may be provided with an extension wall part for forming, together with an outer peripheral surface of the flange part, a labyrinth seal.

According to another aspect of the present invention, there is provided a recording disk driving device including: the spindle motor as described above rotating a recording disk; a head transfer unit transferring a head reading information from the recording disk mounted on the spindle motor to and from the recording disk; and a housing receiving the spindle motor and the head transfer unit therein.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1;

FIG. 3 is an enlarged view of part B of FIG. 1; and

FIG. 4 is a schematic cross-sectional view showing a recording disk driving device according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

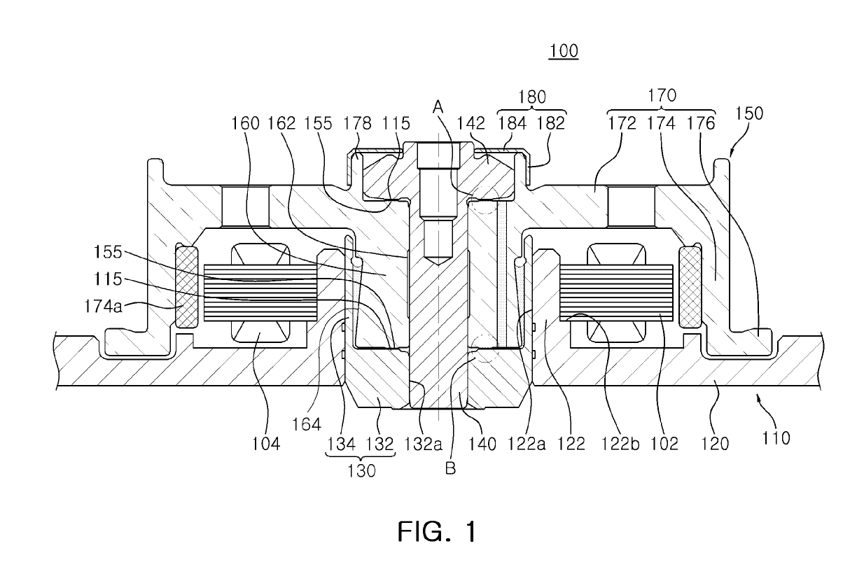

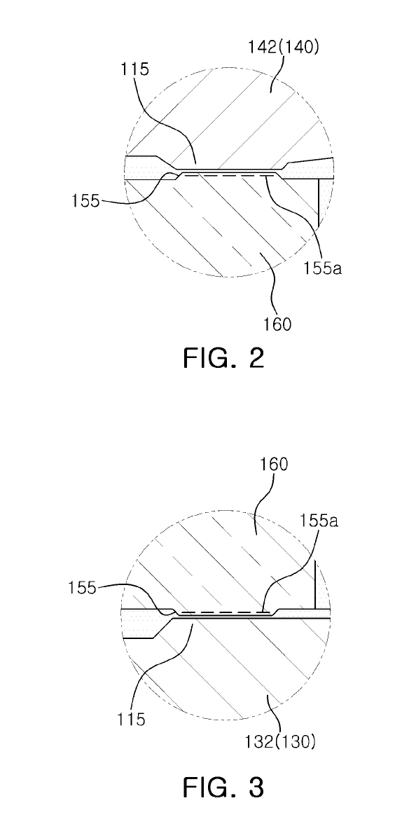

FIG. 1 is a schematic cross-sectional view showing a spindle motor according to an embodiment of the invention; FIG. 2 is an enlarged view of part A of FIG. 1; and FIG. 3 is an enlarged view of part B of FIG. 1.

Referring to FIGS. 1 through 3, a spindle motor 100 according to an embodiment of the invention may include a fixed member 110 and a rotating member 150 by way of example.

Meanwhile, the spindle motor 100 according to the embodiment of the invention may be a motor used in an information recording and reproducing device such as a hard disk driving device, or the like.

The fixed member 110 may rotatably support the rotating member 150.

Meanwhile, the fixed member 110 may include a protrusion corresponding portion 115 protruded so as to be disposed to face a protrusion portion 155 formed at the rotating member 150.

Hereinafter, the fixed member 110 will be described in more detail. The fixed member 110 may include a base member 120, a lower thrust member 130, and a shaft 140 by way of example.

The base member 120 may be provided with an installation part 122 on which a stator core 102 is installed. The installation part 122 may form an installation hole 122a into which the above-mentioned lower thrust member 130 is inserted and may be extended upwardly in an axial direction.

Meanwhile, the installation part 122 may include a support surface 122b formed on an outer peripheral surface thereof, wherein the support surface 122b supports the stator core 102. For example, the stator core 102 may be fixedly installed on the installation part 112 in a state in which it is seated on the support surface 122b of the installation part 122.

Although the case in which an inner diameter portion of the stator core 102 is seated on the installation part 122 of the base member 120 has been described by way of example in the present embodiment, the invention is not limited thereto. That is, the stator core 102 may also be installed on a separate installation member or the lower thrust member of which a shape is changed in order to install the stator core 102. In this case, the base member 120 may not be provided with the installation part 122.

The lower thrust member 130 may be insertedly disposed in the installation hole 122a of the installation part 122 and have an outer peripheral surface bonded to an inner peripheral surface of the installation part 122.

Here, the lower thrust member 130 may be fixedly installed in the installation part 122 in at least one of an adhering scheme, a press-fitting scheme, and a welding scheme.

Meanwhile, the lower thrust member 130 may include a disk part 132 having a disk shape and provided with a through-hole 132a into which a lower end portion of the shaft 140 is inserted and a sealing wall part 134 extended from an edge of the disk part 132 upwardly in the axial direction.

In addition, a distal end portion of the sealing wall part 134 may be disposed to be adjacent to a lower surface of a rotor hub 170 of a rotating member 150, and a detailed description thereof will be provided below.

In addition, the lower thrust member 130 may form, together with the rotating member 150, a bearing clearance in which a lubricating fluid is provided, and the sealing wall part 134 may form, together with the rotating member 150, a sealing part in which an interface (that is, a liquid-vapor interface) between the lubricating fluid and air is formed.

Further, the disk part 132 may have the above-mentioned protrusion corresponding portion 115 formed on an upper surface thereof. That is, the protrusion corresponding portion 115 may be formed on the disk part 132 so as to form a clearance narrower than a bearing clearance in order to smoothly generate thrust fluid dynamic pressure.

A detailed description thereof will also be provided below.

The lower end portion of the shaft 140 may be fixedly installed in the lower thrust member 130 and an upper end portion thereof may be provided with a flange part 142.

For example, the lower end portion of the shaft 140 may be inserted into the through-hole 132a of the lower thrust member 130 to thereby be fixedly installed in the lower thrust member 130. That is, the spindle motor 100 according to the embodiment of the invention may have a fixed shaft structure in which the shaft 140 is fixed in place.

Meanwhile, the shaft 140 may form, together with the rotating member 150, a bearing clearance in which the lubricating fluid is provided, and the flange part 142 may have a protrusion corresponding portion 115 formed on a lower surface thereof.

Further, the lower surface of the flange part 142 of the shaft 140 may form, together with the rotating member 150, a sealing part in which a liquid-vapor interface is formed.

The rotating member 150 may include a sleeve 160 forming, with respect to the lower thrust member 130 and the shaft 140, the bearing clearances, and the rotor hub 170 extended from the sleeve 160.

Here, terms with respect to directions will be defined. As viewed in FIG. 1, an axial direction refers to a vertical direction, that is, a direction from a lower end portion of the shaft 140 toward an upper end portion thereof or a direction from the upper end portion of the shaft 140 toward the lower end portion thereof, and a radial direction refers to a horizontal direction, that is, a direction from the shaft 140 toward an outer peripheral surface of the rotor hub 170 or from the outer peripheral surface of the rotor hub 170 toward the shaft 140.

In addition, a circumferential direction refers to a rotation direction along the outer peripheral direction of the shaft 140.

The sleeve 160 may be disposed between the flange part 142 of the shaft 140 and the disk part 132 of the lower thrust member 130 and form, together with the shaft 140 and the lower thrust member 130, the bearing clearances.

Meanwhile, the sleeve 160 may include a shaft hole 162 formed therein, wherein the shaft hole 122 has the shaft 140 penetrating therethrough.

In addition, upper and lower radial dynamic pressure grooves (not shown) may be formed in at least one of an inner peripheral surface of the sleeve 160 and the outer peripheral surface of the shaft 140. The upper and lower radial dynamic pressure grooves may be disposed to be spaced apart from each other in the axial direction and generate fluid dynamic pressure in the radial direction at the time of rotation of the sleeve 160.

Therefore, the rotating member 150 may be more stably rotated.

In addition, the sleeve 160 may include the protrusion portion 155 formed so as to correspond to the above-mentioned protrusion corresponding portion 115.

For example, the protrusion portions 155 may be formed on upper and lower surfaces of the sleeve 160. Although the case in which the protrusion portions 155 are formed on the upper and lower surfaces of the sleeve 160 has been described by way of example in the present embodiment, the invention is not limited thereto. That is, the protrusion portion 155 may only be formed on either of the upper or lower surface of the sleeve 160.

In addition, the protrusion portion 155 may include a thrust dynamic pressure groove 155a formed therein in order to generate thrust fluid dynamic pressure as shown in FIGS. 2 and 3. Further, the thrust dynamic pressure groove 155a may have a spiral pattern or a herringbone pattern.

Meanwhile, the protrusion corresponding portion 115 corresponding to the protrusion portion 155 may be formed on at least one of the lower thrust member 130 and the flange part 142. Although the case in which the protrusion corresponding portions 115 are formed on both of the lower thrust member 130 and the flange part 142 has been described by way of example in the present invention, the invention is not limited thereto.

In addition, a radial length of the protrusion portion 155 in which the thrust dynamic pressure groove 155a is formed maybe smaller than that of the protrusion corresponding portion 115 disposed to face the protrusion portion 155 and having a flat surface.

For example, edges of the protrusion portion 155 may be disposed inwardly of edges of the protrusion corresponding portion 115. Thus, an edge of the protrusion portion 155 and an edge of the protrusion corresponding portion 115 disposed to face the edge of the protrusion portion 155 may be disposed to be spaced apart from each other.

Meanwhile, a distance between the edges of the protrusion portion 155 and the protrusion corresponding portion 115 may be larger than a gap of a clearance formed by the protrusion portion 155 and the protrusion corresponding portion 115.

Therefore, the generation of foreign objects due to abrasion of the edge of the protrusion portion 155 and the edge of the protrusion corresponding portion 115 at the time of contact between the protrusion portion 155 and the protrusion corresponding portion 115 may be prevented. In other words, in the case in which the radial lengths of the protrusion portion 155 and the protrusion corresponding portion 115 are the same as each other, the edges of the protrusion portion 155 and the edges of the protrusion corresponding portion 115 may be disposed on the same virtual vertical line. In this case, when the protrusion portion 115 and the protrusion corresponding portion 115 contact each other, the edges of the protrusion portion 155 and the edges of the protrusion corresponding portion 115 contact each other. Therefore, fragments may be separated from the edges of the protrusion portion 155 and the protrusion corresponding portion 115 and subsequently introduced into the lubricating fluid to cause deterioration of rotational characteristics due thereto.

However, as described above, the edges of the protrusion portion 155 is disposed inwardly of the edges of the protrusion corresponding portion 115 in the radial direction to prevent the edges of the protrusion portion 155 and the edges of the protrusion corresponding portion 115 from contacting each other, whereby the generation of the foreign objects may be prevented.

In addition, the edges of the protrusion portion 155 is disposed inwardly of the edges of the protrusion corresponding portion 115, whereby damage to the thrust dynamic pressure groove 155a formed in the protrusion portion 155 may be prevented.

A detailed description thereof will be provided below. In the case in which the radial length of the protrusion portion 155 is greater than that of the protrusion corresponding portion 115, when the protrusion portion 155 and the protrusion corresponding portion 115 contact each other, the edges of the protrusion corresponding portion 115 may contact the thrust dynamic pressure groove 155a formed in the protrusion portion 155. Therefore, more abrasion may be generated in the thrust dynamic pressure groove 155a formed in the protrusion portion 155 than in other portions, by the edges of the protrusion corresponding portion 115.

In this case, dynamic pressure generated by the thrust dynamic pressure groove 155a is decreased, whereby rotational characteristics may be deteriorated.

However, as described above, since the protrusion portion 155 has the radial length smaller than that of the protrusion corresponding portion 115, damage to the thrust dynamic pressure groove 155a due to the edges of the protrusion corresponding portion 115 at the time of contact between the protrusion portion 155 and the protrusion corresponding portion 115 may be prevented.

As a result, the deterioration of the rotational characteristics may be prevented.

Meanwhile, the sleeve 160 may have an inclined surface 164 formed on a lower portion of an outer peripheral surface thereof in order to form, together with the sealing wall part 134 of the lower thrust member 130, the liquid-vapor interface. Therefore, an interface between the lubricating fluid and the air may be formed in a space between the inclined surface 164 and an inner peripheral surface of the sealing wall part 134 by a capillary phenomenon.

In addition, a distal end of the sealing wall part 134 maybe disposed to be adjacent to the lower surface of the rotor hub 170. Therefore, an upper end portion of the inner peripheral surface of the sealing wall part 134 may be disposed to face an upper end portion of the outer peripheral surface of the sleeve 160. In other words, the upper end portion of the inner peripheral surface of the sealing wall part 134 and the upper end portion of the outer peripheral surface of the sleeve 160 may form a labyrinth seal.

As described above, since the upper end portion of the inner peripheral surface of the sealing wall part 134 and the upper end portion of the outer peripheral surface of the sleeve 160 may form the labyrinth seal, evaporation of the lubricating fluid may be decreased, and leakage of the lubricating fluid may be prevented.

The rotor hub 170 may be extended from the sleeve 160. Meanwhile, although the case in which the rotor hub 170 and the sleeve 160 are formed integrally with each other has been described by way of example in the present embodiment, the invention is not limited thereto. That is, the rotor hub 170 and the sleeve 160 may be manufactured separately from each other and then coupled to each other.

In addition, the rotor hub 170 may include a body 172 having a disk shape, a magnet mounting part 174 extended from an edge of the body 172 downwardly in the axial direction, and a disk support part 176 extended from a distal end of the magnet mounting part 174 in the radial direction.

In addition, the magnet mounting part 174 may include a driving magnet 174a fixedly installed on an inner surface thereof. Therefore, an inner surface of the driving magnet 174a may be disposed to face a front end of the stator core 102.

Meanwhile, the driving magnet 174a may be a permanent magnet generating magnetic force having a predetermined strength by alternately magnetizing an N pole and an S pole thereof in the circumferential direction.

Here, a rotational driving scheme of the rotating member 150 will be schematically described. When power is supplied to a coil 104 wound around the stator core 102, driving force capable of rotating the rotating member 150 may be generated by electromagnetic interaction between the stator core 102 having the coil 104 wound therearound and the driving magnet 174a to rotate the rotating member 150.

That is, the driving magnet 174a and the stator core 102 disposed to face the driving magnet 174a and having the coil 104 wound therearound may interact with each other electromagnetically to rotate the rotating member 150.

Meanwhile, the rotor hub 170 may be provided with an extension wall part 178 for forming, together with an outer peripheral surface of the flange part 142 of the shaft 140, a labyrinth seal. The extension wall part 178 may be extended from a central portion of an upper surface of the body 172 upwardly in the axial direction and have a ring shape.

In addition, the spindle motor 100 according to the embodiment of the invention may further include a cap member 180 fixedly installed on the extension wall part 178 to prevent leakage of the lubricating fluid.

Meanwhile, the cap member 180 may include a bonded part 182 having an inner peripheral surface bonded to an outer peripheral surface of the extension wall part 178 and a cover part 184 bent from the bonded part 182 inwardly in the radial direction.

That is, in the case in which the bonded part 182 of the cap member 180 is bonded to the extension wall part 178, the cover part 184 may be disposed over the flange part 142 of the shaft 140 to prevent the leakage of the lubricating fluid.

Meanwhile, the cap member 180 is not an indispensable component of the spindle motor 100 according to the embodiment of the invention, and the cap member 180 may be omitted. In other words, the cap member 180 may not be included in the spindle motor 100 according to the embodiment of the invention.

As described above, the radial length of the protrusion portion 155 in which the thrust dynamic pressure groove 155a is formed may be smaller than that of the protrusion corresponding portion 115 disposed to face the protrusion portion 155 and having the flat surface.

Therefore, the contact between the edges of the protrusion portion 155 and the edges of the protrusion corresponding portion 115 may be prevented, whereby the generation of the foreign objects may be prevented.

In addition, the edges of the protrusion portion 155 is disposed inwardly of the edges of the protrusion corresponding portion 115, whereby the damage to the thrust dynamic pressure groove 155a formed in the protrusion portion 155 may be prevented.

Meanwhile, although the fixed shaft structure in which the shaft 140 is fixed has been described by way of example in the present embodiment, the technical spirit of the invention is not limited thereto, but may also be applied to a rotating shaft structure. That is, the technical spirit of the invention may be applied to a spindle motor having a rotating shaft structure including a thrust dynamic pressure groove.

Hereinafter, a recording disk driving device according to an embodiment of the invention will be described with reference to the accompanying drawings.

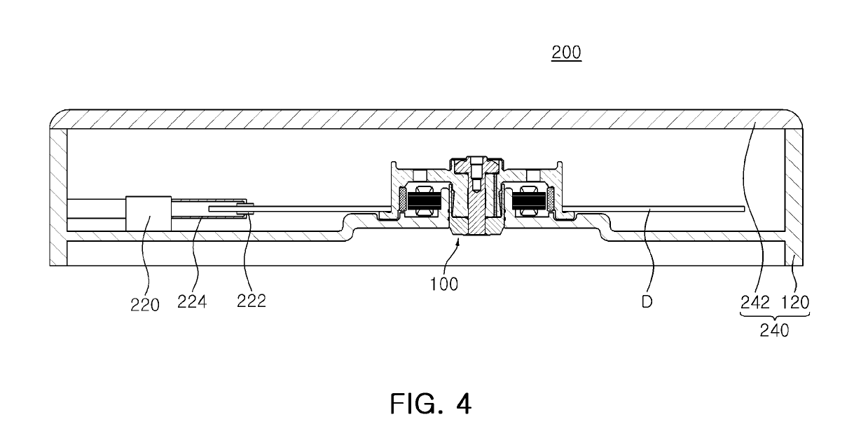

FIG. 4 is a schematic cross-sectional view showing a recording disk driving device according to an embodiment of the invention.

Referring to FIG. 4, a recording disk driving device 200 according to the embodiment of the invention may be a hard disk drive and may include a spindle motor 100, a head transfer unit 220, and a housing 240.

The spindle motor 100 may have all of the above-mentioned features and may have a recording disk D mounted thereon.

The head transfer unit 220 may transfer a head 222 for reading information from a recording disk D mounted on the spindle motor 100 to a position above a surface of the recording disk D from which information is to be read. The head 222 may be disposed on a support member 224 of the head transfer unit 220.

The housing 240 may include a base member 120 and a top cover 242 shielding an upper portion of the base member 120 in order to form an internal space receiving the spindle motor 100 and the head transfer unit 220.

As set forth above, according to embodiments of the invention, a radial length of a portion in which a thrust dynamic pressure groove is formed is smaller than a radial length of a facing surface in which the thrust dynamic pressure groove is not formed, whereby damage to the thrust dynamic pressure groove may be decreased. Further, the generation of foreign objects may be prevented.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a rotating member including a protrusion portion protruded so as to form a clearance narrower than a bearing clearance; and
a fixed member having a protrusion corresponding portion protruded so as to be disposed to face the protrusion portion and rotatably supporting the rotating member,
wherein the protrusion portion includes a thrust dynamic pressure groove formed therein in order to generate thrust fluid dynamic pressure and has a radial length smaller than that of the protrusion corresponding portion disposed to face the thrust dynamic pressure groove and having a flat surface.

2. The spindle motor of claim 1, wherein the fixed member includes:
a base member including an installation part on which a stator core is installed;
a lower thrust member inserted into the installation part; and
a shaft having a lower end portion fixedly installed in the lower thrust member and an upper end portion provided with a flange part.

3. The spindle motor of claim 2, wherein the rotating member includes:
a sleeve forming, together with the lower thrust member and the shaft, the bearing clearance; and
a rotor hub extended from the sleeve.

4. The spindle motor of claim 3, wherein the protrusion portion is formed on at least one of upper and lower surfaces of the sleeve, and
the protrusion corresponding portion is formed on at least one of the lower thrust member and the flange part.

5. The spindle motor of claim 3, wherein the lower thrust member includes:
a disk part having a disk shape and provided with a through-hole; and
a sealing wall part extended from an edge of the disk part upwardly in an axial direction and having a distal end portion disposed to be adjacent to a lower surface of the rotor hub.

6. The spindle motor of claim 3, wherein the rotor hub is provided with an extension wall part for forming, together with an outer peripheral surface of the flange part, a labyrinth seal.

7. The spindle motor of claim 6, further comprising a cap member fixedly installed on the extension wall part to prevent leakage of a lubricating fluid.

8. A spindle motor comprising:
a base member including an installation part on which a stator core is installed;
a lower thrust member inserted into the installation part;
a shaft having a lower end portion fixedly installed in the lower thrust member and an upper end portion provided with a flange part;
a rotating member including a sleeve forming, together with the lower thrust member and the shaft, a bearing clearance and a rotor hub extended from the sleeve; and
a cap member fixedly installed on the rotor hub to prevent leakage of a lubricating fluid from a liquid-vapor interface disposed in a space formed between the flange part and the rotor hub,
wherein at least one of upper and lower surfaces of the sleeve is provided with a protrusion portion, and at least one of a lower surface of the flange part and an upper surface of the lower thrust member is provided with a protrusion corresponding portion corresponding to the protrusion portion, the protrusion portion including a thrust dynamic pressure groove formed therein in order to generate thrust fluid dynamic pressure and having a radial length smaller than that of the protrusion corresponding portion.

9. The spindle motor of claim 8, wherein the lower thrust member includes:
a disk part having a disk shape and provided with a through-hole; and
a sealing wall part extended from an edge of the disk part upwardly in an axial direction and having a distal end portion disposed to be adjacent to a lower surface of the rotor hub.

10. The spindle motor of claim 8, wherein the rotor hub is provided with an extension wall part for forming, together with an outer peripheral surface of the flange part, a labyrinth seal.

11. A recording disk driving device comprising:
the spindle motor of claim 1 rotating a recording disk;
a head transfer unit transferring a head reading information from the recording disk mounted on the spindle motor to and from the recording disk; and
a housing receiving the spindle motor and the head transfer unit therein.
